(19) United States
(12) Patent Application Publication
(10) Pub. No.: US 2009/0151192 A1
(43) Pub. Date: Jun. 18, 2009

(54) Household appliance with air exhaust outlet

(75) Inventor: Thomas Nawrot, Berlin (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/316,440

(22) Filed: Dec. 12, 2008

(30) Foreign Application Priority Data
Dec. 18, 2007 (DE) 10 2007 060 852.9

(51) Int. Cl. F26B 21/06; D06F 58/04; F26B 21/00

(52) U.S. Cl. 34/526; 34/130; 34/527

(57) ABSTRACT

The household appliance has an exhaust air outlet to which an exhaust air guide duct can be connected, with the household appliance having an air condition sensor in the area of the exhaust air outlet.

### BACKGROUND OF THE INVENTION

The invention relates to a domestic appliance with an exhaust air outlet, to which an exhaust air guide duct can be connected, in particular a tumble drying device and an extractor hood.

### SUMMARY OF THE INVENTION

In the case of conventional domestic appliances which generate exhaust air, e.g. a vented air tumble dryer or an extractor hood, an exhaust air guide (exhaust air tube, pipe etc.) must be connected to the device. There is a plurality of variables which lead to the optimum exhaust air quantity not being reached, for instance a plurality of connectible exhaust air guides which are available on the market (e.g. DIY stores) but are not matched to the present device, e.g. in terms of the cross-sections and the materials; an arrangement which is not favorable for the flow and leads to contamination over the service life of the domestic appliance. Previously the state of an exhaust air guide was analyzed in a time-consuming fashion by a service technician, generally undertaking a visual inspection, particularly if there is poor access to the exhaust air guide.

It is thus an object of the invention to provide an easily implementable possibility of detecting a state of an exhaust air guide in the case of domestic appliances thus equipped.

This object is achieved by a domestic appliance with an exhaust air outlet as claimed in the independent claim. Advantageous embodiments can be taken in particular from the dependent claims.

The inventive domestic appliance has an exhaust air outlet, to which an exhaust air guide duct can be connected. The domestic appliance also has at least one air condition sensor for detecting a physical property, in particular flow property, of the exhaust air, in particular a flow resistance. The air condition sensor is arranged beyond the air outlet side (downstream) of an exhaust air fan. The domestic appliance also has a control unit, which is set up to receive at least one measured air condition value (e.g. pressure or speed) of the at least one air condition sensor and to determine an exhaust air flow state of the exhaust air guide duct as a function of the level of the measured value. For simple implementation purposes, the domestic appliance also has an exhaust air duct test function as a separate mode of operation, during the activation of which the domestic appliance senses the at least one measured air condition value under load and determines the exhaust air flow state of the exhaust air guide duct by means of the control unit.

In order to reduce an influence of the domestic appliance on a pressure measurement, the air condition sensor is preferably arranged close to the opening of the exhaust air outlet.

The physical state (e.g. pressure, flow speed) of the exhaust air guide duct (exhaust air tube, pipe, shaft etc.) can be determined by means of the air condition sensor. The lower the flow resistance of the exhaust air guide duct, the better its structural state or state caused by an operation. The flow resistance can basically be inferred for instance at least indirectly by means of the pressure level or a flow speed inside the internal exhaust air duct, in particular at the exhaust air outlet. The lower the pressure level and/or the higher the flow speed, the lower the flow resistance and thus the better the state of the exhaust air guide duct. The pressure level at the exhaust air outlet, which corresponds approximately to the value at the start of the exhaust air guide duct, ideally corresponds to the atmospheric pressure of the exhaust air guide duct (negligible flow resistance). The higher the pressure level, the poorer the ventilation effect.

Especially preferred is a domestic appliance in which the exhaust air flow state has at least two state ranges, namely
a first state range, in which the measured air condition value has a measure which allows operation of the domestic appliance without adverse effects on performance or without significant adverse effects on performance caused by the exhaust air guide duct; and
a further state range, in which the measured air condition value has a measure which only allows operation of the domestic appliance with significant adverse effects on performance caused by the exhaust air guide duct.

Determining when performance is significantly adversely effected is typically dependent on the device and is mostly predetermined and set ex-works. For instance, performance may be significantly adversely effected if a drying time delay compared with the ideal or initial state of 15 to 25%, especially approximately 20% or more occurs.

The distinction between these two state ranges can be made for instance by not reaching and/or exceeding a threshold value by the measured air condition value or a state value derived therefrom. If a measured value lies below the threshold value, the first state range (e.g. “exhaust air guide ok”) is assumed and then if the measured value lies above the threshold value, the further state range (e.g. “exhaust air guide deficient”) is assumed. The threshold value can be determined empirically for instance and predetermined ex-works.

A finer distinction and improved user information is enabled if the exhaust air flow state has at least three state ranges, with the further state range being subdivided into a second state range and a third state range, with the measured air state value having a measure in the third state range which only allows operation of the domestic appliance with greater power losses than in the second state range. A warning is then able to be issued to the user for example prior to the occurrence of significant extraction power losses. The second state range can then correspond to a warning range (e.g. “exhaust air guidance deteriorating”), while the third state range corresponds to greater adverse effects on extraction power (e.g. “exhaust air guidance deficient”).

With the presence of the exhaust air duct test function, it is particularly advantageous if the domestic appliance is a tumble drying device and is operated after activation of the exhaust air duct test function with a motor, but without heating; as a result of which the state determination can be implemented in particularly effectively reproducible fashion.

To increase the level of efficiency of the domestic appliance, it is advantageous if the control unit is set up to emit an exhaust air test prompt display after a predetermined number of actuations (e.g. 230 drying cycles in a tumble dryer and/or washer/dryer) and/or after a predetermined period of time since its last activation of the exhaust air duct test function (e.g. a year) has passed. The exhaust air test prompt display indicates to the user that an exhaust air test (in more precise terms: a test of the state of the exhaust air guide duct) is to be implemented. The exhaust air test prompt display may include a display in a display unit or an illumination of a lamp for instance.

It is also advantageous for the control unit to be set up to output an exhaust air test prompt display prior to a first activation of the exhaust air duct test function after connection of the domestic appliance. This especially enables a structurally-related state of the exhaust air guide duct to be analyzed.

The air state sensor preferably includes a pressure sensor. The measured air state value is then a measured pressure value. This enables the state to be measured in a simple and cost-effective way for example.

The pressure sensor preferably includes a differential pressure sensor for detecting a differential pressure between a pressure at the exhaust air outlet and an atmospheric pressure. The pressurized measured value is then a pressurized differential measured value. This compensates for any influence of the atmospheric pressure on the pressure measurement at the installation site for example.

In addition or alternatively, the air state sensor can however also comprise a volume flow sensor, e.g. an impeller anemometer. The measured air condition value is then a measured exhaust air speed value.

It may be preferable if the domestic appliance has several, in particular annularly arranged sensor apertures, in particular static pressure holes.

It may also be preferable if the domestic appliance has several air condition sensors.

It may also be preferable if the domestic appliance has an exhaust air guide duct.

### BRIEF DESCRIPTION OF THE DRAWINGS

The invention is described schematically in more detail below with reference to an exemplary embodiment.

FIG. 1 shows a cross section of a vented tumble dryer viewed from the side.

### DETAILED DESCRIPTION OF EXEMPLARY EMBODIMENTS OF THE PRESENT INVENTION

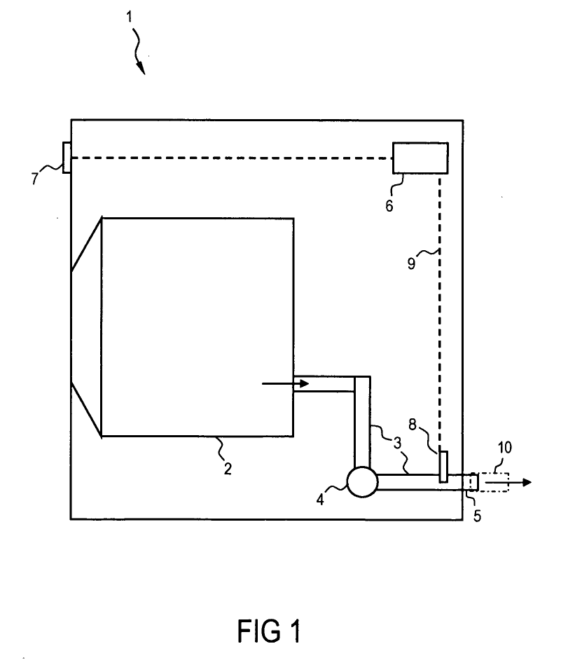

FIG. 1 shows an exhaust air tumble dryer 1 with selected components. The structure of vented tumble dryers is essentially well known and typically has a drum housing 2 for receiving a rotatably mounted laundry drum (without Fig.), an internal exhaust air duct 3, which leads from the drum housing 2 via an exhaust air fan 4 to an exhaust air outlet 5 positioned downstream in respect of the exhaust air fan 4. An exhaust air guide duct 10 can be connected to the exhaust air outlet 5. The tumble dryer 1 also has a control unit 6, by means of which different drying programs and modes of operation activated and selected by a user on a control panel 7 can be controlled. The control panel typically has different operating and display means, e.g. rotary selector switches, buttons, LCD or LED displays and/or lamps and suchlike.

In contrast to the previously known devices, the tumble dryer 1 also has a differential pressure sensor 8, which is partially introduced into the exhaust air duct 3 of the tumble dryer 1 next to the exhaust air outlet 5 by means of a static pressure hole. This position corresponds to a position shortly before a start of the exhaust air guide duct 10 if such is connected. The differential pressure sensor 8 is connected to the control unit 6 by means of a signal line 9. This enables the control unit 6 to receive measured values (static pressure compared with atmospheric pressure) sensed by the pressure sensor 8.

On the control panel 7, the drying device 1 has an essentially known operating mode selector switch (not shown), which is now extended inter alia however by the mode of operation “exhaust air check”. In this mode of operation, only the motor operates and not the heater. The user should preferably have the exhaust air guide 10 connected. The drum does not need to contain washing. A lint filter should preferably to be removed or clean. After activation of this mode of operation, e.g. after approximately 15 seconds, the customer is shown a recommendation on a display unit (not shown) of the control panel 7.

For its part this recommendation can typically read as follows;

The exhaust air guide is:
i) Optimal, device operates optimally;
ii) Not optimal, device does not operate optimally
iii) Poor, please optimize without fail and/or clean (device otherwise only runs at reduced power).

These three state ranges i) to iii) are distinguished and/or defined here by way of differential pressure ranges, with state range i) corresponding to a lowest differential pressure range, e.g. [0; 150-200] Pa, state range ii) corresponding to a mid differential pressure range, which connects to the highest value of the lowest differential pressure range, e.g. [150-200; 250] Pa and state range iii) corresponding to a highest differential pressure range, which connects to the highest value of the average differential pressure range , e.g. [250 . . . ∞] Pa.

The user is to implement this exhaust air guide duct measurement preferably before first operation (after connecting the device) as well as e.g. once a year and/or after 230 drying processes for instance. This can be stored in the control unit 6. The user is made aware of the occurrence of the above conditions by a corresponding exhaust air test prompt display appearing, for instance a notification is shown in the display unit (e.g. “please perform exhaust air guide check”) or a corresponding light-emitting diode (e.g. an LED) illuminates.

The user is given the option, by analyzing the exhaust air guide state, of being able to operate the domestic appliance 1 with an optimal exhaust air output and thus the best possible overall performance. To this end, the user is given a possibility of testing his/her exhaust air guide and improving it in terms of design. As a result, the performance of the domestic appliance is improved, in particular energy consumption is reduced. The user also achieves the possibility of detecting gradual contamination in the exhaust air guide duct.

The present invention is naturally not restricted to the embodiment shown.

1. A domestic appliance comprising:
an exhaust fan;
an exhaust air outlet, to which an exhaust air guide duct can be connected downstream of the exhaust fan;
an air state sensor for detecting a physical property of an exhaust air in response to an activation of an exhaust air test function; and
a controller that receives a measured air state value from the air state sensor and that determines an exhaust air flow state of the exhaust air guide based upon the measured air state value in response to the activation of the exhaust air test function.

2. The domestic appliance of claim 1, wherein the air state sensor is in an area of the exhaust air outlet.

3. The domestic appliance of claim 1, wherein the controller determines whether the exhaust air flow state corresponds to a first state range or a second state range, the first state range being an exhaust air flow state that enables operation of the domestic appliance without adverse affects on performance or without significant adverse affects on performance caused by the exhaust air guide duct and the second state range being an exhaust air flow state that enables an operation of the domestic appliance only with significant adverse effects on performance caused by the exhaust air guide duct.

4. The domestic appliance of claim 1, wherein the controller determines whether the exhaust air flow state corresponds to a first state range, a second state range, or a third state range, the first state range being an exhaust air flow state that enables operation of the domestic appliance without adverse affects on performance or without significant adverse affects on performance caused by the exhaust air guide duct, the second state range being an exhaust air flow state that enables an operation of the domestic appliance only with significant adverse effects on performance caused by the exhaust air guide duct, and the third state range being an exhaust air flow state that enables an operation of the domestic appliance only with significant adverse effects on performance caused by the exhaust air guide duct that is more than the significant adverse effects on performance caused by the exhaust air guide duct in the second state range.

5. The domestic appliance of claim 1, wherein the domestic appliance comprises a tumbler dryer that is operated after activating the exhaust air duct test function without heating.

6. The domestic appliance of claim 1, wherein the controller outputs an exhaust air test prompt display after a predetermined number of actuations.

7. The domestic appliance of claim 1, wherein the controller outputs an exhaust air test prompt display after a predetermined duration has passed since activation of the exhaust air duct test function.

8. The domestic appliance of claim 1, wherein the controller outputs an exhaust air test prompt function prior to a first activation of the exhaust air duct test function after connecting the domestic appliance.

9. The domestic appliance of claim 1, wherein the air state sensor comprises a pressure sensor.

10. The domestic appliance of claim 9, wherein the pressure sensor comprises a differential pressure sensor for detecting a differential pressure between a pressure at the exhaust air outlet and an atmospheric pressure.

11. The domestic appliance of claim 1, wherein the air state sensor comprises a volume flow measuring sensor.

12. The domestic appliance of claim 1, wherein the exhaust air outlet comprises several, annularly arranged pressure apertures.

13. The domestic appliance of claim 1, further comprising an exhaust air guide duct.
